(19) United States
(12) Patent Application Publication
(10) Pub. No.: US 2025/0028951 A1
(43) Pub. Date: Jan. 23, 2025

(54) DATA ANALYSIS APPARATUS AND METHOD

(71) Applicants: HYUNDAI MOTOR COMPANY, Seoul (KR); KIA CORPORATION, Seoul (KR)

(72) Inventors: Jung Hwan Bang, Seongnam-si (KR); Byeong Wook Jeon, Seoul (KR)

(73) Assignees: HYUNDAI MOTOR COMPANY, Seoul (KR); KIA CORPORATION, Seoul (KR)

(21) Appl. No.: 18/524,596

(22) Filed: Nov. 30, 2023

(30) Foreign Application Priority Data
Jul. 17, 2023 (KR) 10-2023-0092617

(51) Int. Cl. G06N 3/08; G06N 5/022

(52) U.S. Cl. CPC G06N 3/08; G06N 5/022

(57) ABSTRACT

A data analysis apparatus and a method thereof are provided. The data analysis apparatus includes a memory that stores a neural network model and a program instruction and a processor that executes the program instruction. The processor inputs at least one of a first dataset, a second dataset, or any combination thereof to the neural network model, in response to identifying the second dataset obtained during a first specified duration before a time point when the first dataset is obtained. The processor obtains a governing equation corresponding to a portion of a plurality of neurons included in the neural network model. The processor changes the portion of the plurality of neurons included in the neural network model to the governing equation. The processor obtains a third dataset for predicting data during a second specified duration after the time point, from the neural network model.

### CROSS-REFERENCE TO RELATED APPLICATION

This application claims the benefit of and priority to Korean Patent Application No. 10-2023-0092617, filed in the Korean Intellectual Property Office on Jul. 17, 2023, the entire contents of which are incorporated herein by reference.

### TECHNICAL FIELD

The present disclosure relates to a data analysis apparatus and a method thereof and more particularly relates to technologies of analyzing data using a neural network model.

### BACKGROUND

An artificial intelligence (AI) model is used in various fields. Particularly, the AI model may predict future data using past data or current data, in a field associated with time series prediction.

Various studies for describing a correlation between input data input to the AI model and output data output from the AI model are in progress. For example, a correlation between input data and output data may be described by applying explainable artificial intelligence (XAI), but only a correlation between input data and output data is described for only a relatively simply AI model.

A method for describing a correlation between input data input to a high-level AI model and output data output from the high-level AI model and identifying a physical characteristic of the high-level model is discussed.

The statements in this section merely provide background information related to the present disclosure and may not constitute prior art.

### SUMMARY

The present disclosure has been made to solve the above-mentioned problems occurring in the prior art while advantages achieved by the prior art are maintained intact.

An aspect of the present disclosure provides a data analysis apparatus for changing a portion of a neural network model to a governing equation, analyzing data, and analyzing the neural network model and a correlation of the analyzed data and a method thereof.

Another aspect of the present disclosure provides a data analysis apparatus for assisting in easily identifying the influence of data obtained in the past on data predicted in the future, using a neural network model including a governing equation and a method thereof.

Another aspect of the present disclosure provides a data analysis apparatus for analyzing a correlation between input data input to a neural network model including a relatively large number of hidden layers and output data output from the neural network model and analyzing a physical characteristic of the neural network model and a method thereof.

The technical problems to be solved by the present disclosure are not limited to the aforementioned problems, and any other technical problems not mentioned herein should be clearly understood from the following description by those having ordinary skill in the art to which the present disclosure pertains.

According to an aspect of the present disclosure, a data analysis apparatus may include a memory that stores a neural network model and a program instruction and a processor that executes the program instruction.

In an embodiment, the processor may input at least one of a first dataset, a second dataset, or any combination thereof to the neural network model, in response to identifying the second dataset obtained during a first specified duration before a time point when the first dataset is obtained using at least one of a hardware component included in a vehicle, a software component included in the vehicle, or any combination thereof. The processor may obtain a governing equation corresponding to a portion of a plurality of neurons included in the neural network model, in response to inputting the at least one of the first dataset, the second dataset, or the any combination thereof to the neural network model. The processor may change the portion of the plurality of neurons included in the neural network model to the governing equation, in response to obtaining the governing equation. The processor may obtain a third dataset for predicting data during a second specified duration after the time point, from the neural network model. The portion of the plurality of neurons of the neural network model is changed to the governing equation.

In an embodiment, the processor may identify at least one of at least one constant included in the governing equation, a coefficient of at least one variable included in the governing equation, or any combination thereof, in response to inputting the at least one of the first dataset, the second dataset, or the any combination thereof to the changed neural network model including the governing equation.

In an embodiment, the at least one of the first dataset, the second dataset, or the any combination thereof may include at least one of a first input including first parameters associated with driving of the vehicle, a second input including second parameters associated with a surrounding environment of the vehicle, or any combination thereof.

In an embodiment, the processor may obtain a polynomial corresponding to a portion different from a portion corresponding to the governing equation included in the changed neural network model, using at least one of the first dataset, the second dataset, the governing equation, or any combination thereof.

In an embodiment, the processor may output first information for describing the polynomial, using at least one of global explainable artificial intelligence (XAI), local XAI, or any combination thereof. The global XAI may include at least one of a linear regression model, a surrogate model, or any combination thereof. The local XAI may include at least one of layer-wise relevance propagation (LRP), deep learning important features (LIFT), integrated gradients, or any combination thereof.

In an embodiment, the neural network model may include a model for predicting a speed of the vehicle. The processor may obtain a feature value corresponding to at least one of a driving resistance coefficient acting on the vehicle, a weight of the vehicle, or any combination thereof, based on the at least one of the first dataset, the second dataset, or the any combination thereof. The processor may obtain the governing equation and a polynomial different from the governing equation, using at least one of the feature value, the first dataset, the second dataset, or any combination thereof.

In an embodiment, the processor may identify a difference between a system feature value of the vehicle and a physical feature value obtained based on the neural network model. The system feature value is obtained by a hardware component different from the data analysis apparatus included in the vehicle. The processor may identify that at least one of training data for training the neural network model, the neural network model, or any combination thereof is in an abnormal state, based on the difference.

In an embodiment, the processor may obtain second information for describing the changed neural network model, based on that the third dataset is output from the at least one of the first dataset, the second dataset, or the any combination thereof.

In an embodiment, the neural network model may include a model for predicting a speed of the vehicle. The first parameters associated with the driving of the vehicle may include at least one of a road slope, whether an accelerator pedal of the vehicle operates, a steering angle of the vehicle, whether a brake of the vehicle operates, a position of a shift gear of the vehicle, a distance between the vehicle and an outside vehicle located in front of the vehicle, engine revolutions per minute (RPM) of the vehicle, pressure of a brake master cylinder included in the vehicle, a speed difference between the vehicle and the outside vehicle located in front of the vehicle, a rotational angle of the vehicle, a speed of the vehicle, or any combination thereof. The second parameters associated with the surrounding environment of the vehicle may include at least one of a distance between the vehicle and an outside vehicle located in front of the vehicle, a speed difference between the vehicle and the outside vehicle located in front of the vehicle, a road slope, a rotational angle of the vehicle, a road sign, or any combination thereof.

In an embodiment, the neural network model may be trained to calculate parameters associated with an operation of obtaining the data during the second specified duration, using the governing equation.

According to another aspect of the present disclosure, a data analysis method may include inputting at least one of a first dataset, a second dataset, or any combination thereof to a neural network model, in response to identifying the second dataset obtained during a first specified duration before a time point when the first dataset is obtained using at least one of a hardware component included in a vehicle, a software component included in the vehicle, or any combination thereof. The data analysis method may also include obtaining a governing equation for changing a portion of a plurality of neurons included in the neural network model, in response to inputting the at least one of the first dataset, the second dataset, or the any combination thereof to the neural network model. The data analysis method may also include changing the portion of the plurality of neurons included in the neural network model to the governing equation, in response to obtaining the governing equation. The data analysis method may also include obtaining a third dataset for predicting data during a second specified duration after the time point, from the neural network model. The portion of the plurality of neurons of the neural network model is changed to the governing equation.

The data analysis method according to an embodiment may further include identifying at least one of at least one constant included in the governing equation, a coefficient of at least one variable included in the governing equation, or any combination thereof, in response to inputting the at least one of the first dataset, the second dataset, or the any combination thereof to the changed neural network model including the governing equation.

In an embodiment, the at least one of the first dataset, the second dataset, or the any combination thereof may include at least one of a first input including first parameters associated with driving of the vehicle, a second input including second parameters associated with a surrounding environment of the vehicle, or any combination thereof.

The data analysis method according to an embodiment may further include obtaining a polynomial corresponding to a portion different from a portion corresponding to the governing equation included in the changed neural network model, using at least one of the first dataset, the second dataset, the governing equation, or any combination thereof.

The data analysis method according to an embodiment may further include outputting first information for describing the polynomial, using at least one of global explainable artificial intelligence (XAI), local XAI operation, or any combination thereof. The global XAI may include at least one of a linear regression model, a surrogate model, or any combination thereof. The local XAI may include at least one of layer-wise relevance propagation (LRP), deep learning important features (LIFT), integrated gradients, or any combination thereof.

In an embodiment, the neural network model may include a model for predicting a speed of the vehicle. The data analysis method may further include obtaining a feature value corresponding to at least one of a driving resistance coefficient acting on the vehicle, a weight of the vehicle, or any combination thereof, based on the at least one of the first dataset, the second dataset, or the any combination thereof. The data analysis method may further include obtaining the governing equation and a polynomial different from the governing equation, using at least one of the feature value, the first dataset, the second dataset, or any combination thereof.

The data analysis method according to an embodiment may further include identifying a difference between a system feature value of the vehicle and a physical feature value obtained based on the neural network model. The system feature value being obtained by a hardware component different from the data analysis apparatus included in the vehicle. The data analysis method may further include identifying that at least one of training data for training the neural network model, the neural network model, or any combination thereof is in an abnormal state, based on the difference.

The data analysis method according to an embodiment may further include obtaining second information for describing the changed neural network model, based on that the third dataset is output from the at least one of the first dataset, the second dataset, or the any combination thereof.

In an embodiment, the neural network model may include a model for predicting a speed of the vehicle. The first parameters associated with the driving of the vehicle may include at least one of a road slope, whether an accelerator pedal of the vehicle operates, a steering angle of the vehicle, whether a brake of the vehicle operates, a position of a shift gear of the vehicle, a distance between the vehicle and an outside vehicle located in front of the vehicle, engine revolutions per minute (RPM) of the vehicle, pressure of a brake master cylinder included in the vehicle, a speed difference between the vehicle and the outside vehicle located in front of the vehicle, a rotational angle of the vehicle, a speed of the vehicle, or any combination thereof. The second parameters associated with the surrounding environment of the vehicle may include at least one of a distance between the vehicle and an outside vehicle located in front of the vehicle, a speed difference between the vehicle and the outside vehicle located in front of the vehicle, a road slope, a rotational angle of the vehicle, a road sign, or any combination thereof.

In an embodiment, the neural network model may be trained to calculate parameters associated with an operation of obtaining the data during the second specified duration, using the governing equation.

### BRIEF DESCRIPTION OF THE DRAWINGS

The above and other objects, features, and advantages of the present disclosure should be more apparent from the following detailed description taken in conjunction with the accompanying drawings:

FIG. 1 illustrates an example of a block diagram of a data analysis apparatus according to an embodiment of the present disclosure;

FIG. 2 illustrates an example in which a portion of a neural network model changes to a governing equation, according to an embodiment of the present disclosure;

FIG. 3 illustrates an example in which a data analysis apparatus predicts a speed of a vehicle using datasets according to an embodiment of the present disclosure;

FIG. 4 illustrates an example in which a data analysis apparatus predicts a speed of a vehicle according to an embodiment of the present disclosure;

FIG. 5 illustrates an example of a flowchart about a data analysis method according to an embodiment of the present disclosure; and

FIG. 6 illustrates a computing system associated with a data analysis apparatus according to an embodiment of the present disclosure.

### DETAILED DESCRIPTION

Hereinafter, some embodiments of the present disclosure are described in detail with reference to the drawings. In the drawings, the same reference numerals are used throughout to designate the same or equivalent elements. In addition, a detailed description of well-known features or functions has been omitted in order not to unnecessarily obscure the gist of the present disclosure.

In describing the components of the embodiment according to the present disclosure, terms such as first, second, “A”, “B”, (a), (b), and the like may be used. These terms are only used to distinguish one element from another element and do not limit the corresponding elements to the order or priority of the corresponding elements. Furthermore, unless otherwise defined, all terms including technical and scientific terms used herein should be interpreted as is customary in the art to which the present disclosure belongs. It should be understood that terms used herein should be interpreted as having a meaning that is consistent with their meaning in the context of the present disclosure and the relevant art. The terms should not be interpreted in an idealized or overly formal sense unless expressly so defined herein. When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

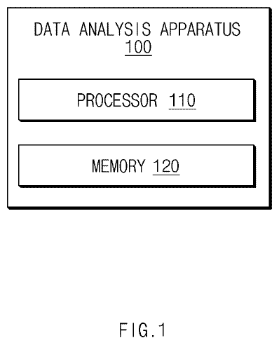

Hereinafter, embodiments of the present disclosure are described in detail with reference to FIGS. 1-6.

FIG. 1 illustrates an example of a block diagram of a data analysis apparatus according to an embodiment of the present disclosure.

Referring to FIG. 1, a data analysis apparatus 100 according to an embodiment of the present disclosure may be implemented in a vehicle. In this case, the data analysis apparatus 100 may be integrally configured with control units in the vehicle or may be implemented as a separate device to be connected with the control units of the vehicle by a separate connection means.

The data analysis apparatus 100 may include a processor 110 and a memory 120. The processor 110 and the memory 120 may be electronically or operably coupled with each other by an electronical component including a communication bus.

Hereinafter, when pieces of hardware are operably coupled with each other, the coupling may include that a direct connection or an indirectly connection between the pieces of hardware established in a wired or wireless manner. Thus, a second hardware is controlled by a first hardware among the pieces of hardware. The different blocks are illustrated, but an embodiment is not limited thereto. Some of the pieces of hardware of FIG. 1 may be included in a single integrated circuit including a system on a chip (SoC). Types of the pieces of hardware included in the data analysis apparatus 100 or the number of the pieces of hardware is limited to those shown in FIG. 1. For example, the data analysis apparatus 100 may include only some of the pieces of hardware shown in FIG. 1.

The processor 110 of the data analysis apparatus 100 according to an embodiment may include hardware for processing data in response to one or more program instructions. The hardware for processing the data may include the processor 110.

For example, the hardware for processing the data may include at least one of an arithmetic and logic unit (ALU), a floating point unit (FPU), a field programmable gate array (FPGA), a central processing unit (CPU), an application processor (AP), or any combination thereof.

For example, the processor 110 may have a structure of a single-core processor or may have a structure of a multi-core processor including a dual core, a quad core, a hexa core, or an octa core. However, embodiments of the present disclosure are not limited thereto.

The memory 120 of the data analysis apparatus 100 according to an embodiment may include a hardware component for storing at least one of data input or output from the processor 110 of the data analysis apparatus 100, a program instruction, a neural network model, or any combination thereof.

For example, the memory 120 may include a volatile memory including a random-access memory (RAM) or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof.

For example, the non-volatile memory may include at least one of a programmable ROM (PROM), an erasable PROM (EPROM), an electrically erasable PROM (EEPROM), a flash memory, a hard disk, a compact disc, a solid state drive (SSD), an embedded multi-media card (eMMC), or any combination thereof.

For example, the memory 120 of the data analysis apparatus 100 may store one or more instructions (or program instructions) indicating calculation or an operation to be performed for data by the processor 110 of the data analysis apparatus 100. For example, a set of the one or more instructions may be referred to as at least one of a program, firmware, an operating system, a process, a routine, a sub-routine, an application, or any combination thereof.

The memory 120 of the data analysis apparatus 100 according to an embodiment may include a neural network model. For example, the neural network model may include a vehicle speed prediction model for predicting a speed of a vehicle. However, embodiments of the present disclosure are not limited thereto. For example, the neural network model may be trained based on at least one of supervised learning, unsupervised learning, or any combination thereof.

For example, the neural network model 210 may include at least one layer. For example, the neural network model may include at least one of an input layer, at least one hidden layer, an output layer, or any combination thereof. For example, the at least one of the input layer, the at least one hidden layer, the output layer, or the any combination thereof may include at least one neuron.

For example, the neural network model may output data or an output dataset through the output layer, in response to propagating input data or an input dataset input to the input layer to the at least one hidden layer.

The processor 110 of the data analysis apparatus 100 according to an embodiment may obtain a dataset using at least one of a hardware component included in the vehicle, a software component included in the vehicle, or any combination thereof.

For example, the hardware component may include at least one sensor. For example, the at least one sensor may include at least one of a speed sensor, an acceleration sensor, a yaw rate sensor, a steering sensor, or any combination thereof. For example, the hardware component may transmit data obtained using the at least one sensor to the processor 110.

For another example, the software component may transmit a dataset including data, data processing of which is performed, to the processor 110, based on the data processing for the data obtained by means of the at least one sensor described above.

In an embodiment, the processor 110 may identify a time point when a first dataset is obtained using the at least one of the hardware component included in the vehicle, the software component included in the vehicle, or the any combination thereof. The processor 110 may identify a second dataset obtained during a first specified duration before the time point when the first dataset is obtained. The processor 110 may input at least one of the first dataset, the second dataset, or any combination thereof to the neural network model included in the memory 120, in response to identifying the second dataset obtained during the first specified duration before the time point when the first dataset is obtained.

For example, the at least one of the first dataset, the second dataset, or the any combination thereof may include a first input including first parameters associated with driving of the vehicle.

For example, the at least one of the first dataset, the second dataset, or the any combination thereof may include a second input including second parameters associated with a surrounding environment of the vehicle.

As described above, the at least one of the first dataset, the second dataset, or the any combination thereof may include the first input including the first parameters associated with the driving of the vehicle, the second input including the second parameters associated with the surrounding environment of the vehicle, or any combination thereof.

For example, the first parameters associated with the driving of the vehicle may include at least one of a road slope, whether the accelerator pedal of the vehicle operates, a steering angle of the vehicle, whether the brake of the vehicle operates, a position of the shift gear of the vehicle, a distance between the vehicle and an outside vehicle located in front of the vehicle, engine revolutions per minute (RPM) of the vehicle, pressure of the brake master cylinder included in the vehicle, a speed difference between the vehicle and the outside vehicle located in front of the vehicle, a rotational angle of the vehicle, a speed of the vehicle, or any combination thereof.

For example, the second parameters associated with the surrounding environment of the vehicle may include a distance between the vehicle and an outside vehicle located in front of the vehicle, a speed difference between the vehicle and the outside vehicle located in front of the vehicle, a road slope, a rotational angle of the vehicle, a road sign, or any combination thereof.

In an embodiment, the processor 110 may obtain a governing equation corresponding to some of a plurality of neurons included in the neural network model, in response to inputting the at least one of the first dataset, the second dataset, or the any combination thereof to the neural network model. For example, the governing equation may include an equation for mathematically describing the law of nature. For example, the governing equation may include an equation for expressing the system of the vehicle expressed in time series.

For example, in the vehicle speed prediction model for predicting a speed of the vehicle, the governing equation may include Equation 1 below.

$$m \ddot{x} = F ( t ) - ( {F}_{0} + {F}_{1} \dot{x} + {F}_{2} {\dot{x}}^{2} ) - mg sin θ \qquad [ Equation 1 ]$$

In Equation 1 above, for example, mx may be associated with the force in which the vehicle moves. For example, (F₀+F₁\dot{x}+F₂\dot{x}²) may be associated with the driving resistance according to the speed of the vehicle. \dot{x} may be associated with the speed of the vehicle. For example, \ddot{x} may be associated with the acceleration of the vehicle. For example, mgsinθ may be associated with the force by the road slope (or the gradient of the road). For example, F(t) may include the force associated with at least one of the motor of the vehicle, the brake of the vehicle, or any combination thereof.

When F(t) is “0” or a specific value in Equation 1 above, the processor 110 may obtain at least one of m, F₀, F₁, or F₂, or any combination thereof, using at least one of \dot{x}, \ddot{x}, or x, or any combination thereof. For example, the processor 110 may apply a least square method to at least one of \dot{x}, \ddot{x}, x, or any combination thereof to obtain at least one of m, F₀, F₁, F₂, or any combination thereof.

In an embodiment, the processor 110 may model mx included in Equation 1 above as a function for at least one of the first input including the first parameters, the second input including the second parameters, or any combination thereof. The processor 110 may eliminate a portion corresponding to the governing equation, in response to modeling mx included in Equation 1 above. The processor 110 may model F(t) included in Equation 1 above as a function for at least one of the first input including the first parameters, the second input including the second parameters, or any combination thereof, in response to eliminating the portion corresponding to the governing equation. The processor 110 may obtain a polynomial for describing a portion except for the portion corresponding to the governing equation, in response to modeling F(t) included in Equation 1 above.

For example, the processor 110 may obtain an output (or an output value), based on the first input and the second input, which are input to the neural network model. For example, the processor 110 may obtain a specified number (e.g., about 10) of outputs, based on the first input and the second input.

In an embodiment, the processor 110 may change the some of the plurality of neurons included in the neural network model to the obtained governing equation, in response to obtaining the governing equation corresponding to the some of the plurality of neurons included in the neural network model.

In an embodiment, the processor 110 may obtain a polynomial different from the governing equation included in the changed neural network model, using at least one of the first dataset, the second dataset, or the any combination thereof. For example, the polynomial may include an equation for describing a portion, which is not described by the governing equation. For the vehicle speed prediction model, the polynomial may include a polynomial associated with an intention of a driver.

In an embodiment, the processor 110 may input the at least one of the first dataset, the second dataset, or the any combination thereof to the changed neural network model including the governing equation. The processor 110 may identify at least one of at least one constant included in the governing equation, a coefficient of at least one variable included in the governing equation, or any combination thereof, in response to inputting the at least one of the first dataset, the second dataset, or the any combination thereof to the changed neural network model including the governing equation.

The processor 110 may obtain a third dataset for predicting data during a second specified duration after the time point when the first dataset is obtained, from the neural network model. Some of the plurality of neurons of the neural network model is changed to the governing equation.

In an embodiment, the processor 110 may output first information for describing the polynomial, using at least one of global explainable artificial intelligence (XAI), local XAI, or any combination thereof. For example, the first information for describing the polynomial may be output in the form of a table. For example, the first information for describing the polynomial may be output in the form of a graph. However, embodiments of the present disclosure are not limited thereto.

For example, the global XAI may include at least one of a linear regression model, a surrogate model, or any combination thereof. For example, the local XAI may include at least one of layer-wise relevance propagation (LRP), deep learning important features (LIFT), integrated gradients, or any combination thereof.

For example, LIFT may change an input dataset to change an output dataset and thus may output explainable information. For example, the LRP may calculate a contribution rate of the input dataset using an output and a weight of each of the layers from the output layer to the input layer and may output explainable information. For example, the deep LIFT may calculate contribution rates of the reference value and the input dataset and may output explainable information.

In an embodiment, the processor 110 may obtain a third dataset for predicting data during the second specified duration after the time point when the first dataset is obtained, based on the at least one of the first dataset, the second dataset, or the any combination thereof. The processor 110 may obtain second information for describing the changed neural network model, based on that the third dataset is output from the changed neural network model. The second information may be output in the form of text, a table, or a graph from the changed neural network model. However, embodiments of the present disclosure are not limited thereto.

The one example of the neural network model is described using the vehicle speed prediction model, but an embodiment is not limited thereto.

As described above, the processor 110 included in the data analysis apparatus 100 according to an embodiment may analyze a correlation between a dataset (e.g., the second dataset) obtained in the past and a dataset (e.g., the third dataset) for predicting the future, using the neural network model including the governing equation. In another embodiment, the processor 110 may output information for describing the neural network model. The processor 110 may analyze a correlation between a dataset obtained in the past and a dataset for predicting the future, using the neural network model including the governing equation and may output the analyzed information. Thus, the processor 110 may assist the user to easily determine a physical relationship between the dataset in the past and the dataset for predicting the future.

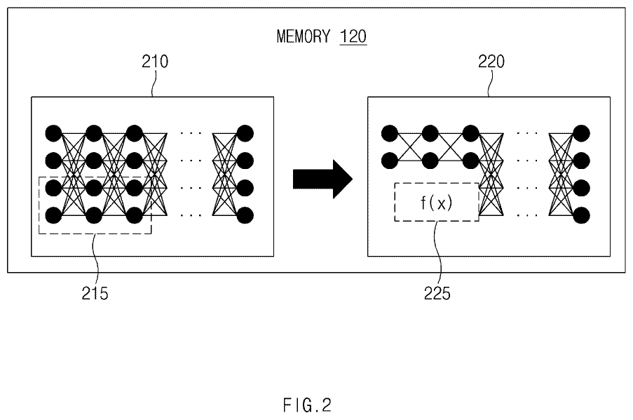

FIG. 2 illustrates an example in which a portion of a neural network model changes to a governing equation, according to an embodiment of the present disclosure.

Operations of FIG. 2 may be performed by a processor 110 included in a data analysis apparatus 100 of FIG. 1.

A memory 120 included in the data analysis apparatus 100 according to an embodiment may include a neural network model 210. For example, the neural network model 210 may include a plurality of layers. For example, the plurality of layers may include at least one of an input layer, a hidden layer, an output layer, or any combination thereof. For example, the neural network model 210 may include a plurality of neurons.

In an embodiment, the processor 110 may input at least one of a first dataset, a second dataset, or any combination thereof to the neural network model 210 included in the memory 120, in response to identifying the second dataset obtained during a first specified duration before a time point when the first dataset is obtained using at least one of a hardware component included in a vehicle, a software component included in the vehicle, or any combination thereof.

For example, a relationship between output data output through the neural network model 210 and input data may be described based on a polynomial including Equation 2 below.

$$F ( t ) = a {x}_{1} + b {x}_{2} + … + c \qquad [ Equation 2 ]$$

For example, the processor 110 may output information for describing the relationship between the output data output through the neural network model 210 and the input data using a first-order polynomial including Equation 2 above. When describing the relationship between the input data and the output data based on Equation 2 above, it may be difficult for a user to identify a physical characteristic.

The processor 110 may obtain a governing equation 225 corresponding to some neurons 215 of the plurality of neurons included in the neural network model 210, in response to inputting the at least one of the first dataset or the second dataset, or the any combination thereof to the neural network model 210.

For example, some neurons 215 of the plurality of neurons may be included in the hidden layer among the plurality of layers including the at least one of the input layer, the hidden layer, or the output layer, or the any combination thereof.

In an embodiment, the processor 110 may change some neurons 215 of the plurality of neurons included in the neural network model 210 to the governing equation 225, in response to obtaining the governing equation 225. The processor 110 may obtain the changed neural network model 220 including the governing equation 225.

When the neural network model 210 is a vehicle speed prediction model for predicting a speed of the vehicle, the processor 110 may obtain the governing equation 225, in response to identifying the second dataset during the first specified duration before the time point when the first data is obtained. For example, the processor 110 may identify feature values for predicting a speed of the vehicle, based on a correlation of the at least one of the first dataset, the second dataset, or the any combination thereof. For example, the feature values in the vehicle speed prediction model may be associated with at least one of driving resistance of the vehicle, a vehicle weight (or mass), or any combination thereof.

In an embodiment, the processor 110 may obtain a third dataset including data for predicting the future, in response to inputting at least one of the first dataset indicating the present, the second dataset indicating the past, or any combination thereof to the changed neural network model 220.

For example, the neural network model 210 or the changed neural network model 220 may be trained to calculate parameters associated with an operation of obtaining data during a second specified duration.

For example, the processor 110 may output information for describing a relationship between datasets (e.g., an input dataset and an output dataset) obtained using the neural network model 220 including the governing equation 225 based on Equation 3 below.

$$F ( t ) = f ( x ) + {a}^{′} {x}_{1} + {b}^{′} {x}_{2} + … + {c}^{′} \qquad [ Equation 3 ]$$

f(x) in Equation 3 above may be referred to as the governing equation 225. The processor 110 may output information for describing a portion of a relationship between input data and output data based on the governing equation 225 and may output information for describing a portion different from the portion described based on the governing equation 225 using a polynomial including a first-order formula, using the neural network model 220 including the governing equation 225.

As described above, the processor 110 of the data analysis apparatus 100 according to an embodiment may use the governing equation 225 to output information for describing the relationship between the input data and the output data using the law of nature.

For example, when predicting the speed of the vehicle based on the neural network model 220 including the governing equation 225, the processor 110 may output information including that “the speed of the vehicle decreases by about 20 km/h, as the force of about −50 N is applied to the vehicle due to a turning road curved at 90° ahead”.

As described above, the processor 110 of the data analysis apparatus 100 according to an embodiment may change the neural network model 210 included in the memory 120 to the neural network model 220 including the governing equation 225. The processor 110 may obtain data (or a dataset) for predicting the future, using at least one of data (or a dataset) obtained in the past, data (or a dataset) obtained at a current time point, or any combination thereof, using the changed neural network model 220. The processor 110 may obtain the data (or the dataset) for predicting the future using the changed neural network model 220 and thus output explainable information.

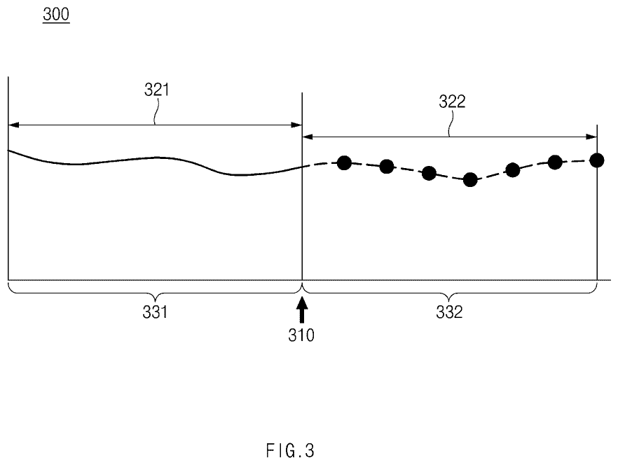

FIG. 3 illustrates an example in which a data analysis apparatus predicts a speed of a vehicle using datasets according to an embodiment of the present disclosure.

Operations of FIG. 3 may be performed by a processor 110 included in a data analysis apparatus 100 of FIG. 1. A description below may include an example in which a neural network model is a vehicle speed prediction model, but an embodiment is not limited thereto.

Referring to FIG. 3, the processor 110 of the data analysis apparatus 100 according to an embodiment may obtain or generate a dataset such as a table 300. For example, the processor 110 may generate a dataset for predicting data in a second specified duration 322, based on at least one of a dataset obtained in a first specified duration 321, a dataset obtained at a time point 310, or any combination thereof in the table 300.

In an embodiment, the processor 110 may identify a second dataset 331 during the first specified duration 321 before the time point 310 when a first dataset is obtained. For example, when obtaining the first dataset, the processor 110 may identify about 5 signals. For example, the second dataset 331 may include data of about 128 sequences identified at intervals of about 0.1 seconds. For example, the sequences included in the second dataset 331 may include about 11 signals. For example, the first specified duration 321 may include a past time interval, which is earlier than the time point 310 when the first dataset is obtained. For example, the first specified duration 321 may include about 128 sequences identified at intervals of about 0.1 seconds to have a length of about 12.8 seconds.

In an embodiment, the processor 110 may calculate a physical feature value of the system, using a correlation between the second dataset 331 including past data and a physical quantity, which requires prediction. For example, the physical quantity, which requires the prediction, may include a speed of a vehicle. For example, the physical feature value of the system may include a weight (or mass) of the vehicle and a coefficient associated with driving resistance acting on the vehicle. The processor 110 may obtain a governing equation including Equation 1 described in FIG. 1, in response to calculating the above-mentioned physical feature value.

In an embodiment, the processor 110 may identify a difference between a system feature value of the vehicle, which is obtained by a hardware component different from the data analysis apparatus 100 and a physical feature value obtained based on the neural network model. The processor 110 may identify an abnormal state of at least one of training data for training the neural network model, the neural network model, or any combination thereof, in response to identifying the difference between the system feature value of the vehicle, which is obtained by the hardware component different from the data analysis apparatus 100 included in the vehicle, and the physical feature value obtained based on the neural network model.

In an embodiment, the processor 110 may change a portion of a neural network model included in a memory to the governing equation, in response to obtaining the governing equation. For example, the processor 110 may change some of a plurality of neurons included in the neural network model to the obtained governing equation. The processor 110 may obtain a dataset for predicting the future, based on datasets input to the changed neural network model including the governing equation.

In an embodiment, the processor 110 may obtain a third dataset 332 for predicting data during the second specified duration 322 after the time point 310 when the first dataset is obtained, in response to inputting the at least one of the second dataset 331 identified during the first specified duration 321, the first dataset, or the any combination thereof to the neural network model.

For example, the third dataset 332 may include about 16 sequences identified at intervals of about 0.8 seconds. As the third dataset 332 includes about 16 sequences identified at intervals of about 0.8 seconds, the second specified duration 322 may have a length of about 12.8 seconds. The third dataset 332 may include a single signal, but an embodiment is not limited thereto.

In an embodiment, the processor 110 may obtain a polynomial different from the governing equation included in the changed neural network model. For example, the polynomial may be obtained based on the at least one of the first dataset, the second dataset 331, or the any combination thereof. For example, the processor 110 may obtain a polynomial different from the governing equation, based on the at least one of the first dataset, the second dataset 331, or the any combination thereof. For example, the polynomial may include an equation for describing non-natural law including an intention of a user.

Equation 4 below may be an equation in which a portion of Equation 1 above in FIG. 1 is modified.

$$F ( t ) = ( {F}_{0} + {F}_{1} \dot{x} + {F}_{2} {\dot{x}}^{2} ) + mg sin θ + m \ddot{x} \qquad [ Equation 4 ]$$

In Equation 4 above, F(t) may be included in the polynomial different from the governing equation. For example, the processor 110 may obtain F(t), based on respective elements, in (F₀+F₁\dot{x}+F₂\dot{x}²)+mgsinθ+m\ddot{x} included in Equation 4 above. For example, the processor 110 may obtain a result value of F(t) from respective sequences included in the second dataset 331, using data corresponding to the respective sequences included in the second dataset 331 and may analyze a tendency of the obtained result value of F(t). The processor 110 may express F(t) as a polynomial, in response to analyzing the tendency of the result value of F(t).

In an embodiment, the processor 110 may perform fitting for a portion except for the some of the plurality of neurons expressed as the governing equation. For example, the processor 110 may perform the fitting for the portion except for the some of the plurality of neurons expressed as the governing equation, using at least one of polynomial fitting, curve fitting, Gaussian function fitting, exponential function fitting, or any combination thereof.

In an embodiment, the processor 110 may obtain F(t) including the polynomial, in response to applying at least one of global XAI, local XAI, or any combination thereof to a portion except for a portion corresponding to the governing equation. F(t) including the polynomial may be referred to as Equation 5 below.

$$F ( t ) = {a}_{11} {x}_{1} + {a}_{12} {x}_{2} + {a}_{13} {x}_{3} + … + {a}_{21} {x}_{1}^{2} + {a}_{22} {x}_{2}^{2} + {a}_{23} {x}_{3}^{2} + … + b \qquad [ Equation 5 ]$$

Equation 5 above may include an example of a polynomial obtained using at least one of a first input including first parameters, a second input including second parameters, or any combination thereof.

For example, when the neural network model is relatively simply designed, the global XAI may be applied when it is explainable with a single function. For example, the local XAI may be applied when it is explainable only when an unknown quantity (or input data) is a specific value. As described above, the processor 110 may output information for describing the neural network model, in response to applying the at least one of the global XAI, the local XAI, or the any combination thereof to F(t) including the polynomial.

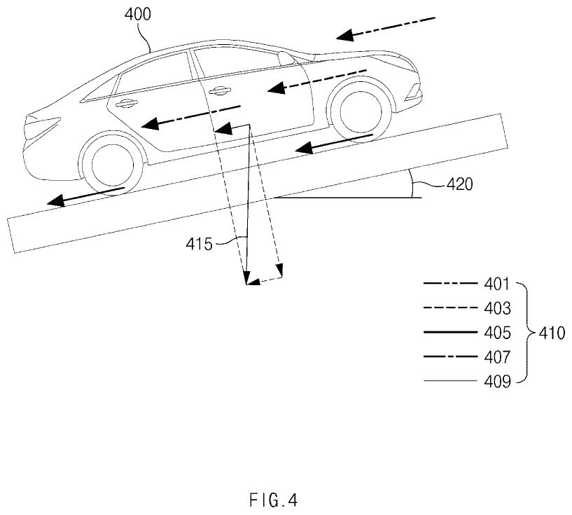

FIG. 4 illustrates an example in which a data analysis apparatus predicts a speed of a vehicle according to an embodiment of the present disclosure.

Operations of FIG. 4 may be performed by a processor 110 included in a data analysis apparatus 100 of FIG. 1.

An example of FIG. 4 includes a description of operations of a data analysis apparatus for predicting a speed of a vehicle, but an embodiment is not limited to predicting the speed of the vehicle. The data analysis apparatus for predicting the speed of the vehicle is described for convenience of description. The data analysis apparatus of the present disclosure may include a data analysis apparatus for analyzing data indicating a time-series relationship.

Referring to FIG. 4, the processor 110 of the data analysis apparatus 100 according to an embodiment may identify forces 410 acting on a vehicle 400. For example, the processor 110 may identify forces associated with a resistance force acting on the vehicle 400.

For example, the forces associated with the resistance force may include an air resistance force 401 acting on the vehicle 400. For example, the forces associated with the resistance force may include an internal resistance force 403 acting on the vehicle 400. For example, the internal resistance force 403 may include a force generated by friction of hardware components included in the vehicle 400. For example, the forces associated with the resistance force may include a rolling friction force 405 acting on wheels of the vehicle 400.

For example, the forces associated with the resistance force may include an inertial force 407 acting on the vehicle 400. For example, the inertial force 407 may be identified based on mass of the vehicle 400 and acceleration of the vehicle 400. For example, the inertial force 407 may include Equation 6 below.

$$Inertial force = m \ddot{x} \qquad [ Equation 6 ]$$

In Equation 6 above, m may indicate the mass of the vehicle 400, and \ddot{x} may indicate the acceleration of the vehicle 400.

For example, the forces associated with the resistance force may include a slope resistance force 409 acting in a direction opposite to a direction of progress of the vehicle 400 by a road slope angle 420. For example, the slope resistance force 409 may be identified based on the force of gravity 415 acting on the vehicle 400, which acts in the Earth's center direction from the vehicle 400. For example, the slope resistance force 409 may be identified based on the force of gravity 415 acting on the vehicle 400 and the road slope angle 420. For example, the slope resistance force 409 may include Equation 7 below.

$$Slope resistance force = mg sin θ \qquad [ Equation 7 ]$$

In Equation 7 above, mg may indicate the force of gravity 415 acting on the vehicle 400, and 0 may indicate the road slope angle 420.

In an embodiment, the processor 110 may obtain a third dataset for predicting data during a second specified duration after a time point when a first dataset is obtained, based on at least one of a governing equation included in a neural network model, a polynomial, or any combination thereof. The processor 110 may analyze a correlation among the first dataset, a second dataset, and the third dataset, in response to obtaining the third dataset.

For example, the processor 110 may obtain information for describing a changed neural network model or information for describing the correlation among the first dataset, the second dataset, and the third dataset, in response to analyzing the correlation among the first dataset, the second dataset, and the third dataset. According to an embodiment, the processor 110 may output the information for describing the changed neural network model or the information for describing the correlation among the first dataset, the second dataset, and the third dataset.

As described above, the processor 110 of the data analysis apparatus 100 according to an embodiment may output information for describing a correlation between at least two of the first dataset, the second dataset, or the third dataset, or any combination thereof. Thus, the processor 110 may assist a user to identify a relationship between data obtained in the past and data for predicting the future.

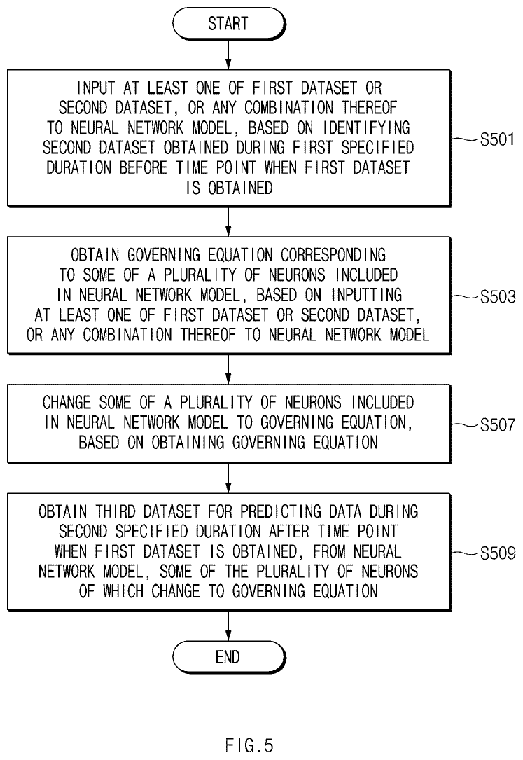

FIG. 5 illustrates an example of a flowchart about a data analysis method according to an embodiment of the present disclosure.

Operations of FIG. 5 may be performed by a processor 110 included in a data analysis apparatus 100 of FIG. 1.

At least one of the operations of FIG. 5 may be performed by the processor 110 included in the data analysis apparatus 100 of FIG. 1. Respective operations of FIG. 5 may be sequentially performed but are not necessarily sequentially performed. For example, an order of the respective operations may be changed, and at least two operations may be performed in parallel.

Referring to FIG. 5, in S501, the processor 110 of the data analysis apparatus 100 according to an embodiment may identify a second dataset obtained during a first specified duration before a time point when a first dataset is obtained using at least one of a hardware component included in a vehicle, a software component included in the vehicle, or any combination thereof.

For example, the second dataset may include a dataset stored in a memory, based on being obtained during the first specified duration before the time point when the first dataset is obtained.

For example, the processor 110 may input at least one of the first dataset, the second dataset, or any combination thereof to a neural network model, in response to identifying the second dataset obtained during the first specified duration. For example, the at least one of the first dataset, the second dataset, or the any combination thereof may include at least one of a first input including first parameters associated with driving of the vehicle, a second input including second parameters associated with a surrounding environment of the vehicle, or any combination thereof.

In S503, according to an embodiment, the processor 110 may obtain a governing equation corresponding to some of a plurality of neurons included in the neural network model, in response to inputting the at least one of the first dataset, the second dataset, or the any combination thereof to the neural network model.

For example, the governing equation may include an equation for describing the law of nature. For example, the governing equation may include an equation for mathematically describing a relationship between dependent variables obtained according to a change in independent variables.

According to an embodiment, the processor 110 may obtain a polynomial for describing a portion different from a portion corresponding to the governing equation from the neural network model, in response to obtaining the governing equation.

In S505, according to an embodiment, the processor 110 may change some of the plurality of neurons included in the neural network model to the governing equation, in response to obtaining the governing equation.

For example, the processor 110 may input the at least one of the first dataset, the second dataset, or the any combination thereof to the neural network model including the governing equation.

In S507, according to an embodiment, the processor 110 may obtain a third dataset for predicting data during a second specified duration after the time point when the first dataset is obtained, from the neural network model. Some of the plurality of neurons of the neural network model is changed to the governing equation.

For example, the second specified duration may have substantially the same length as the first specified duration before the time point when the first dataset is obtained. For example, when the first specified duration is about 12.8 seconds, the second specified duration may be about 12.8 seconds.

As described above, the processor 110 of the data analysis apparatus 100 according to an embodiment may obtain the governing equation corresponding to some of the plurality of neurons included in the neural network model, using the at least one of the first dataset, the second dataset, or the any combination thereof.

The processor 110 may change some of the plurality of neurons included in the neural network model to the obtained governing equation, in response to obtaining the governing equation. The processor 110 may obtain the third dataset for predicting the data after the time point when the first dataset is obtained, in response to inputting the at least one of the first dataset, the second dataset, or the any combination thereof to the neural network model changed to the governing equation as described above.

The processor 110 may output information for describing a correlation among the first dataset, the second dataset, and the third dataset, using the neural network model including the governing equation. The processor 110 may assist a user to relatively easily identify an influence of data obtained in the past on data predicted in the future by outputting the information for describing the correlation among the first dataset, the second dataset, and the third dataset using the neural network model including the governing equation.

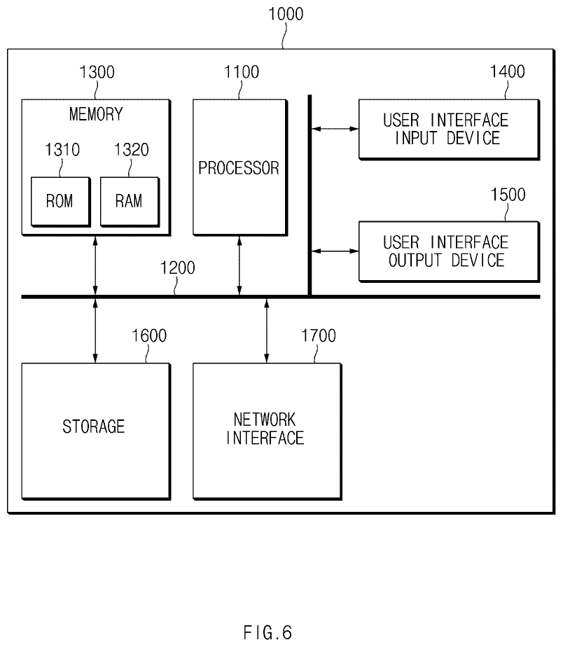

FIG. 6 illustrates a computing system associated with a data analysis apparatus according to an embodiment of the present disclosure.

Referring to FIG. 6, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The present technology may change a portion of a neural network model to a governing equation, may analyze data, and may analyze the neural network model and a correlation of the analyzed data.

Furthermore, the present technology may assist in easily identifying the influence of data obtained in the past on data predicted in the future, using the neural network model including the governing equation.

Furthermore, the present technology may analyze a correlation between input data input to the neural network model including a relatively large number of hidden layers and output data output from the neural network model and may analyze a physical characteristic of the neural network model.

In addition, various effects ascertained directly or indirectly through the present disclosure may be provided.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

Therefore, embodiments of the present disclosure are not intended to limit the technical spirit of the present disclosure, but provided only for the illustrative purpose. The scope of the present disclosure should be construed based on the accompanying claims. All the technical ideas within the scope equivalent to the claims should be included in the scope of the present disclosure.

What is claimed is:

1. A data analysis apparatus, comprising:
a memory configured to store a neural network model and a program instruction; and
a processor configured to:
execute the program instruction;
input at least one of a first dataset, a second dataset, or any combination thereof to the neural network model, in response to identifying the second dataset obtained during a first specified duration before a time point when the first dataset is obtained using at least one of a hardware component included in a vehicle, a software component included in the vehicle, or any combination thereof;
obtain a governing equation corresponding to a portion of a plurality of neurons included in the neural network model, in response to inputting the at least one of the first dataset, the second dataset, or the any combination thereof to the neural network model;
change the portion of the plurality of neurons included in the neural network model to the governing equation, in response to obtaining the governing equation; and
obtain a third dataset for predicting data during a second specified duration after the time point, from the neural network model, wherein the portion of the plurality of neurons of the neural network model is changed to the governing equation.

2. The data analysis apparatus of claim 1, wherein the processor is configured to:
identify at least one of at least one constant included in the governing equation, a coefficient of at least one variable included in the governing equation, or any combination thereof, in response to inputting the at least one of the first dataset, the second dataset, or the any combination thereof to the changed neural network model including the governing equation.

3. The data analysis apparatus of claim 1, wherein the at least one of the first dataset, the second dataset, or the any combination thereof includes at least one of a first input including first parameters associated with driving of the vehicle, a second input including second parameters associated with a surrounding environment of the vehicle, or any combination thereof.

4. The data analysis apparatus of claim 1, wherein the processor is configured to:
obtain a polynomial corresponding to a portion different from a portion corresponding to the governing equation included in the changed neural network model, using at least one of the first dataset, the second dataset, the governing equation, or any combination thereof.

5. The data analysis apparatus of claim 4, wherein the processor is configured to:
output first information for describing the polynomial, using at least one of global explainable artificial intelligence (XAI), local XAI, or any combination thereof,
wherein the global XAI includes at least one of a linear regression model, a surrogate model, or any combination thereof, and
wherein the local XAI includes at least one of layer-wise relevance propagation (LRP), deep learning important features (LIFT), integrated gradients, or any combination thereof.

6. The data analysis apparatus of claim 1, wherein the neural network model includes a model for predicting a speed of the vehicle, and
wherein the processor is configured to:
obtain a feature value corresponding to at least one of a driving resistance coefficient acting on the vehicle, a weight of the vehicle, or any combination thereof, based on the at least one of the first dataset, the second dataset, or the any combination thereof; and
obtain the governing equation and a polynomial different from the governing equation, using at least one of the feature value, the first dataset, the second dataset, or any combination thereof.

7. The data analysis apparatus of claim 1, wherein the processor is configured to:
identify a difference between a system feature value of the vehicle and a physical feature value obtained based on the neural network model, the system feature value being obtained by a hardware component different from the data analysis apparatus included in the vehicle; and
identify that at least one of training data for training the neural network model, the neural network model, or any combination thereof is in an abnormal state, based on the difference.

8. The data analysis apparatus of claim 1, wherein the processor is configured to:
obtain second information for describing the changed neural network model, based on that the third dataset is output from the at least one of the first dataset, the second dataset, or the any combination thereof.

9. The data analysis apparatus of claim 3, wherein the neural network model is configured to:
include a model for predicting a speed of the vehicle, and
wherein the first parameters associated with the driving of the vehicle include at least one of a road slope, whether an accelerator pedal of the vehicle operates, a steering angle of the vehicle, whether a brake of the vehicle operates, a position of a shift gear of the vehicle, a distance between the vehicle and an outside vehicle located in front of the vehicle, engine revolutions per minute (RPM) of the vehicle, pressure of a brake master cylinder included in the vehicle, a speed difference between the vehicle and the outside vehicle located in front of the vehicle, a rotational angle of the vehicle, a speed of the vehicle, or any combination thereof, and
wherein the second parameters associated with the surrounding environment of the vehicle include at least one of a distance between the vehicle and an outside vehicle located in front of the vehicle, a speed difference between the vehicle and the outside vehicle located in front of the vehicle, a road slope, a rotational angle of the vehicle, a road sign, or any combination thereof.

10. The data analysis apparatus of claim 1, wherein the neural network model is configured to:
be trained to calculate parameters associated with an operation of obtaining the data during the second specified duration, using the governing equation.

11. A data analysis method, comprising:
inputting at least one of a first dataset, a second dataset, or any combination thereof to a neural network model, in response to identifying the second dataset obtained during a first specified duration before a time point when the first dataset is obtained using at least one of a hardware component included in a vehicle, a software component included in the vehicle, or any combination thereof;
obtaining a governing equation for changing a portion of a plurality of neurons included in the neural network model, in response to inputting the at least one of the first dataset, the second dataset, or the any combination thereof to the neural network model;
changing the portion of the plurality of neurons included in the neural network model to the governing equation, in response to obtaining the governing equation; and
obtaining a third dataset for predicting data during a second specified duration after the time point, from the neural network model, wherein the portion of the plurality of neurons of the neural network model is changed to the governing equation.

12. The data analysis method of claim 11, further comprising:
identifying at least one of at least one constant included in the governing equation, a coefficient of at least one variable included in the governing equation, or any combination thereof, in response to inputting the at least one of the first dataset, the second dataset, or the any combination thereof to the neural network model changed to the governing equation.

13. The data analysis method of claim 11, wherein the at least one of the first dataset, the second dataset, or the any combination thereof includes at least one of a first input including first parameters associated with driving of the vehicle, a second input including second parameters associated with a surrounding environment of the vehicle, or any combination thereof.

14. The data analysis method of claim 11, further comprising:
obtaining a polynomial corresponding to a portion different from a portion corresponding to the governing equation included in the changed neural network model, using at least one of the first dataset, the second dataset, the governing equation, or any combination thereof.

15. The data analysis method of claim 14, further comprising:
outputting first information for describing the polynomial, using at least one of global explainable artificial intelligence (XAI), local XAI operation, or any combination thereof,
wherein the global XAI includes at least one of a linear regression model, a surrogate model, or any combination thereof, and
wherein the local XAI includes at least one of layer-wise relevance propagation (LRP), deep learning important features (LIFT), integrated gradients, or any combination thereof.

16. The data analysis method of claim 11, wherein the neural network model includes a model for predicting a speed of the vehicle,
wherein the data analysis method further comprises:
obtaining a feature value corresponding to at least one of a driving resistance coefficient acting on the vehicle, a weight of the vehicle, or any combination thereof, based on the at least one of the first dataset, the second dataset, or the any combination thereof; and
obtaining the governing equation and a polynomial different from the governing equation, using at least one of the feature value, the first dataset, the second dataset, or any combination thereof.

17. The data analysis method of claim 11, further comprising:
identifying a difference between a system feature value of the vehicle and a physical feature value obtained based on the neural network model, wherein the data analysis method is performed by a data analysis apparatus included in the vehicle, and wherein the system feature value is obtained by a hardware component different from the data analysis apparatus included in the vehicle; and
identifying that at least one of training data for training the neural network model, the neural network model, or any combination thereof is in an abnormal state, based on the difference.

18. The data analysis method of claim 11, further comprising:
obtaining second information for describing the changed neural network model, based on that the third dataset is output from the at least one of the first dataset, the second dataset, or the any combination thereof.

19. The data analysis method of claim 13, wherein the neural network model is configured to:
include a model for predicting a speed of the vehicle,
wherein the first parameters associated with the driving of the vehicle include at least one of a road slope, whether an accelerator pedal of the vehicle operates, a steering angle of the vehicle, whether a brake of the vehicle operates, a position of a shift gear of the vehicle, a distance between the vehicle and an outside vehicle located in front of the vehicle, engine revolutions per minute (RPM) of the vehicle, pressure of a brake master cylinder included in the vehicle, a speed difference between the vehicle and the outside vehicle located in front of the vehicle, a rotational angle of the vehicle, a speed of the vehicle, or any combination thereof, and
wherein the second parameters associated with the surrounding environment of the vehicle include at least one of a distance between the vehicle and an outside vehicle located in front of the vehicle, a speed difference between the vehicle and the outside vehicle located in front of the vehicle, a road slope, a rotational angle of the vehicle, a road sign, or any combination thereof.

20. The data analysis method of claim 11, wherein the neural network model is configured to:
be trained to calculate parameters associated with an operation of obtaining the data during the second specified duration, using the governing equation.
